(19) United States
(12) Patent Application Publication
(10) Pub. No.: US 2013/0174282 A1
(43) Pub. Date: Jul. 4, 2013

(54) DIGITAL RIGHT MANAGEMENT METHOD, APPARATUS, AND SYSTEM

(71) Applicants: PEKING UNIVERSITY FOUNDER GROUP CO., LTD., Beijing (CN); BEIJING FOUNDER APABI TECHNOLOGY LTD., Beijing (CN); PEKING UNIVERSITY, Beijing (CN); Founder Information Industry Holdings Co., Ltd., Beijing (CN)

(72) Inventors: Xiaoyu CUI, Beijing (CN); Zhi TANG, Beijing (CN)

(73) Assignees: PEKING UNIVERSITY FOUNDER GROUP CO., LTD., Beijing (CN); Founder Information Industry Holdings Co., Ltd., Beijing (CN); PEKING UNIVERSITY, Beijing (CN); BEIJING FOUNDER APABI TECHNOLOGY LTD., Beijing (CN)

(21) Appl. No.: 13/729,593

(22) Filed: Dec. 28, 2012

(30) Foreign Application Priority Data
Dec. 28, 2011 (CN) 201110448295.5

(51) Int. Cl. G06F 21/33

(52) U.S. Cl. CPC G06F 21/33
USPC 726/34

(57) ABSTRACT

A digital right management method, including: encrypting, by a first user equipment which has access right to shared digital contents, a key of the digital contents with at least an equipment key of a second user equipment intended to share the digital contents to generate a ciphertext of the key of the digital contents; generating, by the first user equipment, from the ciphertext a new authorization certificate corresponding to the digital contents; and transmitting, by the first user equipment, the new authorization certificate and the digital contents to the second user equipment to instruct the second user equipment to share the digital contents in accordance with the new authorization certificate.

### RELATED APPLICATIONS

This application is based upon and claims the benefit of priority from Chinese Patent Application No. 201110448295.5, filed Dec. 28, 2011, the entire contents of which are incorporated herein by reference.

### FIELD

The present invention relates to the field of communication technologies and, particularly, to a digital right management method, apparatus, and system.

### BACKGROUND

Digital Right Management (DRM) technologies are generally used to protect electronic books, digital movies, digital music, pictures, software and other digital contents by means of a series of software and hardware technologies. DRM may protect copyright of digital contents with the use of a digital authorization certificate, that is, a user obtaining copyrighted contents has to obtain the corresponding digital authorization certificate and use the digital contents in accordance with use right items granted in the digital authorization certificate. One common practice is to authorize each user individually and to bind protected digital contents with a device currently used by the user so that the obtained digital contents can be used only on the bound device.

However, there have been a variety of devices used by a user along with the constant development of electronic devices and network application technologies, and particularly the user typically possesses a plurality of devices, e.g., a Personal Computer (PC), a notebook computer, a tablet computer, a smart mobile phone, and other devices so that there is a growing demand for the use of protected digital contents. It is often desirable to use the protected digital contents on the plurality of devices. Thus how to enable protected digital contents to be used among a plurality of devices has become an issue in DRM.

### SUMMARY

According to a first aspect of the present disclosure, there is provided a digital right management method, comprising: encrypting, by a first user equipment which has access right to shared digital contents, a key of the digital contents with at least an equipment key of a second user equipment intended to share the digital contents to generate a ciphertext of the key of the digital contents; generating, by the first user equipment, from the ciphertext a new authorization certificate corresponding to the digital contents; and transmitting, by the first user equipment, the new authorization certificate and the digital contents to the second user equipment to instruct the second user equipment to share the digital contents in accordance with the new authorization certificate.

According to a second aspect of the present disclosure, there is provided a first user equipment, comprising: a ciphertext generating module configured to encrypt a key of digital contents with at least an equipment key of a second user equipment intended to share the digital contents to generate a ciphertext of the key of the digital contents; an authorization certificate determining module coupled to the ciphertext generating module and configured to generate from the ciphertext a new authorization certificate corresponding to the digital contents; and an authorization certificate transmitting module coupled to the authorization certificate determining module and configured to transmit the new authorization certificate and the digital contents to the second user equipment to instruct the second user equipment to share the digital contents in accordance with the new authorization certificate.

According to a third aspect of the present disclosure, there is provided a digital right management method, comprising: encrypting, by a server, a key of digital contents with at least an equipment key of a second user equipment intended to share the digital contents to generate a ciphertext of the key of the digital contents; generating, by the server, from the ciphertext a new authorization certificate corresponding to the digital contents; and transmitting, by the server, the new authorization certificate to the second user equipment through a first user equipment which has access to shared the digital contents, to instruct the second user equipment to share the digital contents in accordance with the new authorization certificate.

According to a fourth aspect of the present disclosure, there is provided a digital right management server, comprising: an encrypting module configured to encrypt a key of digital contents with an equipment key of a second user equipment intended to share the digital contents to generate a ciphertext of the key of the digital contents; an authorization certificate generating module coupled to the encrypting module and configured to generate from the ciphertext a new authorization certificate corresponding to the digital contents; and a transmitting module coupled to the authorization certificate generating module and configured to transmit the new authorization certificate to the second user equipment through a first user equipment which has access to shared digital contents to instruct the second user equipment to share the digital contents in accordance with the new authorization certificate.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a general structure of a digital right management system, according to an exemplary embodiment.

FIG. 2 illustrates a block diagram of a digital right management system, according to an exemplary embodiment.

FIG. 3 illustrates a block diagram of a first user equipment in a digital right management system, according to an exemplary embodiment.

FIG. 4 illustrates a block diagram of a server in a digital right management system, according to an exemplary embodiment.

FIG. 5 illustrates a block diagram of a second user equipment in a digital right management system, according to an exemplary embodiment.

FIG. 6 illustrates a flowchart of a digital right management method performed by a first user equipment, according to an exemplary embodiment.

FIG. 7 illustrates a flowchart of a digital right management method performed by a server, according to an exemplary embodiment.

FIG. 8 illustrates a flowchart of a digital right management method performed by a second user equipment, according to an exemplary embodiment.

FIG. 9 illustrates a flowchart of a digital right management method performed by a system, according to an exemplary embodiment.

FIG. 10 illustrates a block diagram of a digital right management system, according to an exemplary embodiment.

FIG. 11 illustrates a block diagram of a server in a digital right management system, according to an exemplary embodiment.

FIG. 12 illustrates a flowchart of a digital right management method performed by a server, according to an exemplary embodiment.

FIG. 13 illustrates a flowchart of a digital right management method performed by a system, according to an exemplary embodiment.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

In exemplary embodiments, one or more modules disclosed in this disclosure may be implemented via one or more processors executing software programs for performing functionalities. In some embodiments, one or more of the disclosed modules are implemented via one or more hardware modules executing firmware for performing functionalities. In some embodiments, one or more of the disclosed modules include storage media for storing data, or software or firmware programs executed by the modules.

In exemplary embodiments, a server or a first user equipment which has shared digital contents, such as having an access right to the digital contents, may generate a new authorization certificate from an equipment key of the first user equipment and an equipment key of a second user equipment intended to share the digital contents, and may transmit the new authorization certificate to the second user equipment intended to share the digital contents, so that the second user equipment may share the corresponding digital contents in accordance with the received new authorization certificate, thus adding a new device to share protected digital contents.

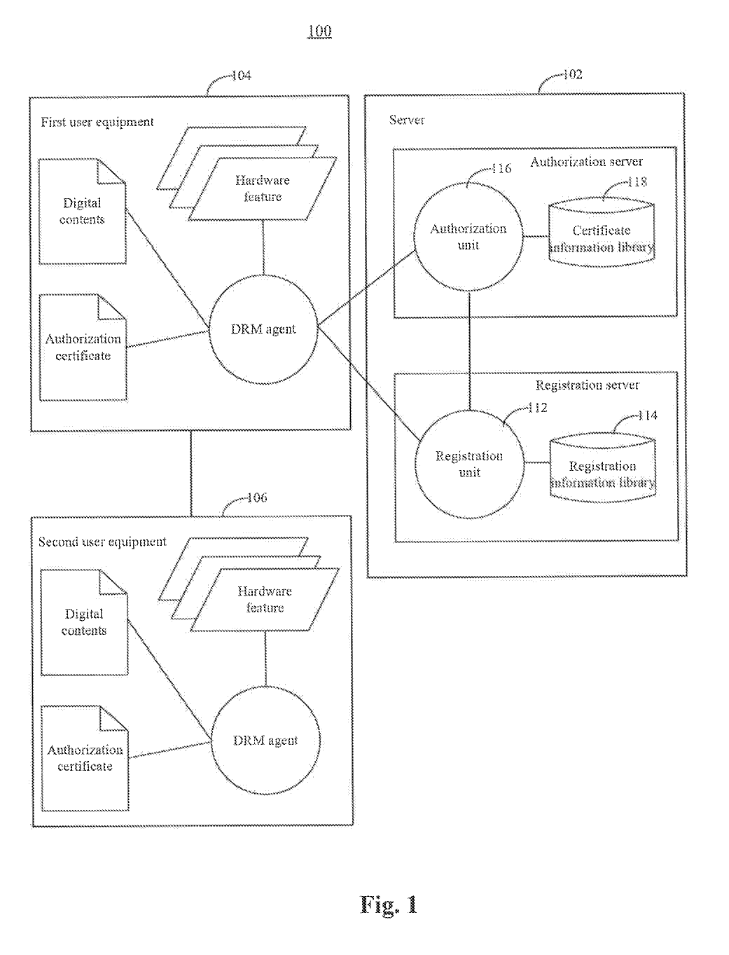

FIG. 1 illustrates a general structure of a digital right management system 100, according to an exemplary embodiment. Referring to FIG. 1, the system 100 includes a server 102, a first user equipment 104 which has shared digital contents, such as having an access right to the digital contents, and a second user equipment 106 intended to share the digital contents. The first user equipment 104 and the second user equipment 106 may each be a Personal Computer (PC), a notebook computer, a portal reader, a tablet computer, a mobile phone with a reading function, etc., and may communicate with each other. first user equipment 104 and the second user equipment 106 may each have, for example, a DRM agent, information about its hardware feature, one or more authorization certificates, and digital contents it has access to or intend to have access to. The server 102 may include a server with an authorization processing function and a registration processing function, or two or more servers independent from each other, e.g., an authorization server and a registration server. The authorization server and the registration server may communicate with each other.

Referring to FIG. 1, before adding a new user equipment to share digital contents, a user may select as needed user equipments intended to use the digital contents, such as the second user equipment 106, registers the selected user equipments with a registration unit 112 of the server 102 provided by an operator of the digital contents, and download the digital contents onto the respective selected user equipments.

After registering the selected user equipments, the registration unit 112 of the server 102 may store registration information including equipment identifiers of the selected user equipments, respectively, and user identity information in a registration information library 114.

The selected user equipments may each transmit a request to an authorization unit 116 of the server 102 to apply for an authorization certificate of the digital contents. Upon reception of the request transmitted from any selected user equipment, the authorization unit 116 of the server 102 may obtain an equipment identifier of the selected user equipment, generate an equipment key of the selected user equipment from the equipment identifier of the selected user equipment. The authorization unit 116 of the server 102 may further encrypt a key of the digital contents with the equipment key of the selected user equipment to generate a ciphertext of the key of the digital contents, generate an authorization certificate from the ciphertext of the key of the digital contents to thereby bind the digital contents with the selected user equipment, store the generated authorization certificate in a certification information library 118 and also transmit the generated authorization certificate to the selected user equipment. In one exemplary embodiment, the authorization certificate may include at least a digital Content IDentifier (CID), a right item to indicate a use right of the user for the digital contents, a signature value to verify the authorization certificate for validity, and the ciphertext of the key of the digital contents. If a plurality of user equipments are selected, for each selected user equipment, the server may generate an authorization certificate corresponding to the selected user equipment from an equipment key of that user equipment, that is, each selected user equipment may correspond to one authorization certificate. Alternatively and/or additionally, the server 102 may generate an authorization certificate from a plurality of equipment keys of all of the selected user equipments, respectively, that is, all of the selected user equipments may correspond to one authorization certificate.

Upon reception of the authorization certificate transmitted from the authorization unit 116 of the server 102, the user equipment which has shared digital contents, e.g., the first user equipment 104, may obtain its own equipment identifier through its DRM agent, generate its own equipment key, decrypt the ciphertext of the key of the digital contents with the equipment key to obtain the key of the digital contents, and further access the digital contents with the key of the digital contents and in accordance with the corresponding right item in the authorization certificate.

Embodiments of the invention provide a digital right management method, apparatus, and system so that the user can add a new user equipment to share digital contents in the course of using a user equipment which has shared the digital contents to access the digital contents. It shall be noted if there are a plurality of user equipments which have shared the digital contents, the user may select the first user equipment 104 from one of them which are able to interact with both the server 102 and the second user equipment 106 intended to share the digital contents.

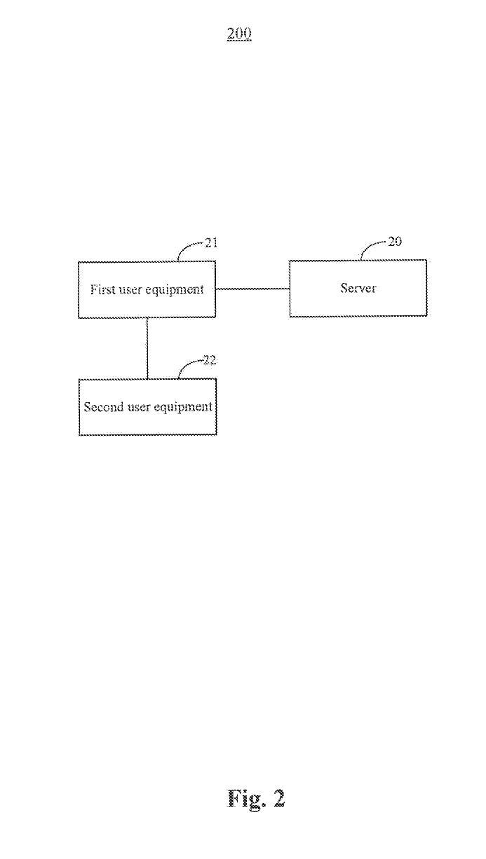

FIG. 2 illustrates a block diagram of a digital right management system 200, according to an exemplary embodiment. Referring to FIG. 2, the system 200 includes a server 20, a first user equipment 21, and a second user equipment 22.

In exemplary embodiments, the server 20 may be configured to receive a sharing request, including a generated digest value, transmitted from the first user equipment 21, to verify the sharing request, to generate a signature value from the digest value after the verification of the sharing request succeeds, and to transmit the generated signature value to the first user equipment 21.

In exemplary embodiments, the first user equipment 21 may be configured to encrypt a key of digital contents with an equipment key of the second user equipment 22, which is intended to share the digital contents, to generate a ciphertext of the key of the digital contents, to generate from the ciphertext a new authorization certificate corresponding to the digital contents, and to transmit the new authorization certificate and the digital contents to the second user equipment 22 to instruct the second user equipment 22 to share the digital contents in accordance with the new authorization certificate.

In exemplary embodiments, the second user equipment 22 may be configured to receive the new authorization certificate and the corresponding digital contents transmitted from the first user equipment 21, and to decrypt the ciphertext of the key of the digital contents in the new authorization certificate with the equipment key of the second user equipment 22, and to obtain the key of the digital contents and further access the digital contents corresponding to the new authorization certificate.

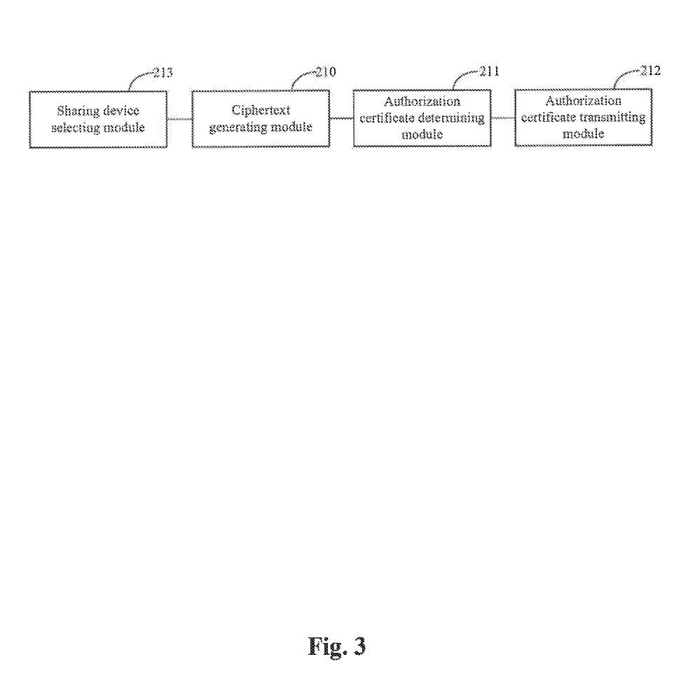

FIG. 3 illustrates a block diagram of the first user equipment 21 in the digital right management system 200 (FIG. 2), according to an exemplary embodiment. Referring to FIGS. 2 and 3, the first user equipment 21 may include a ciphertext generating module 210, an authorization certificate determining module 211, an authorization certificate transmitting module 212, and a sharing device selecting module 213. Each module may be implemented by one or more computer programs executed by one or more processors.

In exemplary embodiments, the ciphertext generating module 210 may be configured to encrypt a key of digital contents with an equipment key DK₁ of the second user equipment 22 intended to share the digital contents to generate a ciphertext of the key of the digital contents. For example, the equipment key DK₁ of the second user equipment 22 may be generated from an obtained equipment identifier of the second user equipment 22.

In exemplary embodiments, the authorization certificate determining module 211 may be configured to generate from the ciphertext a new authorization certificate corresponding to the digital contents. The authorization certificate transmitting module 212 may be configured to transmit the new authorization certificate and the digital contents to the second user equipment 22, to instruct the second user equipment 22 to share the digital contents in accordance with the new authorization certificate.

When there are a plurality of second user equipments, the ciphertext generating module 210 may generate a ciphertext of the key of the digital contents using the following approaches as needed.

In a first embodiment, for each of the second user equipments 22, the ciphertext generating module 210 may encrypt the key of the digital contents with an equipment key of that second user equipment to generate a ciphertext of the key of the digital contents corresponding to that second user equipment. Subsequently, for each of the second user equipments, the authorization certificate determining module 211 may generate a new authorization certificate corresponding to that second user equipment from the ciphertext of the key of the digital contents corresponding to the second user equipment generated by the ciphertext generating module 210. As a result, a plurality of new authorization certificates may be generated.

In a second embodiment, the ciphertext generating module 210 encrypts the key of the digital contents with a plurality of equipment keys of all of the second user equipments, respectively, using a traversal-encryption algorithm to generate a ciphertcxt of the key of the digital contents corresponding to all of the second user equipments. Subsequently, for all of the second user equipments, the authorization certificate determining module 211 may generate a new authorization certificate corresponding to all of the second user equipments from the ciphertext generated by the ciphertext generating module 210. As a result, one new authorization certificate may be generated.

In exemplary embodiments, the ciphertext generating module 210 may be further configured to encrypt the key of the digital contents with an equipment key of the first user equipment 21 and the equipment key of the second user equipment 22 to share the digital contents, to generate a ciphertext of the key of the digital contents. For example, the ciphertext may be obtained by encrypting the key of the digital contents with the equipment key of the first user equipment 21 and the equipment key of the second user equipment 22 using a traversal-encryption algorithm. Also for example, the equipment key of the first user equipment 21 may be generated from an equipment identifier of the first user equipment 21. If there are a plurality of second user equipments, the ciphertext generating module 210 may also generate the ciphertext of the key of the digital contents using the above-described two approaches except that, in the first approach, for each of the second user equipments, the ciphertext generating module 210 encrypts the key of the digital contents with the equipment key of the first user equipment 21 and the equipment key of the second user equipment 22 using a traversal-encryption algorithm; and in the second approach, the ciphertext generating module 210 may encrypt the key of the digital contents by the equipment key of the first user equipment 21 and equipment keys of all of the second user equipments 22 using a traversal-encryption algorithm.

The authorization certificate determining module 211 may be further configured to replace an original authorization certificate of the first user equipment 21 with the new authorization certificate corresponding to the digital contents after generating the new authorization certificate from the ciphertext.

In exemplary embodiments, the authorization certificate determining module 211 may be configured to determine a digest value from the generated ciphertext and the original authorization certificate corresponding to the digital contents, to transmit data including the digest value to the server 20, to receive from the server 20 a signature value generated from the digest value, and to generate the new authorization certificate from the received signature value, the ciphertext of the key of the digital contents, and the original authorization certificate. For example, the transmitted data includes user identity information, a CID of the digital contents, the equipment identifier of the first user equipment 21, the equipment identifier of the second user equipment 22, the generated ciphertext and digest value, etc.

In exemplary embodiments, the authorization certificate determining module 211 may be further configured to perform a hash operation on the generated ciphertext and a right item in the original authorization certificate corresponding to the digital contents, to determine the digest value.

In exemplary embodiments, in the course of interaction between the first user equipment 21 and the server 20, a part or all of transmission data may be encrypted to protect the transmission data for security. For example, the first user equipment 21 may encrypt the equipment identifier HW₀ of the first user equipment 21, the equipment identifier HW₁ of the second user equipment 22, and the generated ciphertext SK, with a public key PubKiu of the server 20 to obtain encrypted data Reqₛ, that is, E(HW₀, HW₁, SK_{c}|PubK_{RI})=Reqₛ, and transmit the user identity information, the CITD of the digital contents, the digest value H_{SK}, and the encrypted data Reqₛ to the server 20.

It shall be noted that, in the above-described first approach, the first user equipment 21 may generate a ciphertext corresponding to each second user equipment and further generate a digest value corresponding to each second user equipment from the ciphertext and a right item of an original authorization certificate. The server 20 may sign each digest value respectively to generate a signature value corresponding to each second user equipment, and finally the first user equipment 21 may generate a new authorization certificate corresponding to each second user equipment from each signature value and transmit the new authorization certificate corresponding to the each second user equipment and the digital contents to the each second user equipment.

In exemplary embodiments, the sharing device selecting module 213 may be configured to select at least one of user equipments currently connected with the first user equipment 21 as the second user equipment 22, to obtain the equipment identifier of the second user equipment 22, and to generate the equipment key of the second user equipment 22 from the equipment identifier of the second user equipment 22. Additionally and/or alternatively, the sharing device selecting module 213 may be configured to select at least one of user equipments transmitting a request to the first user equipment 21 for sharing the digital contents as the second user equipment 22, to obtain the equipment identifier of the second user equipment 22, and to generate the equipment key of the second user equipment 22 from the equipment identifier of the second user equipment 22.

In one exemplary embodiment, the ciphertext generating module 210 may generate the ciphertext using the first embodiment. Accordingly, the equipment key of the second user equipment 22 may be determined from the equipment identifier of the second user equipment 22 before the ciphertext is generated. In one exemplary embodiment, the ciphertext generating module 210 may generate the ciphertext using the second embodiment. Accordingly, the equipment key of the first user equipment 21 may be determined from the equipment identifier of the first user equipment 21 and the equipment key of the second user equipment 22 may be determined from the equipment identifier of the second user equipment 22 before the ciphertext is generated. The first user equipment 21 and the second user equipment 22 may communicate with each other through Bluetooth, infrared or WIFI.

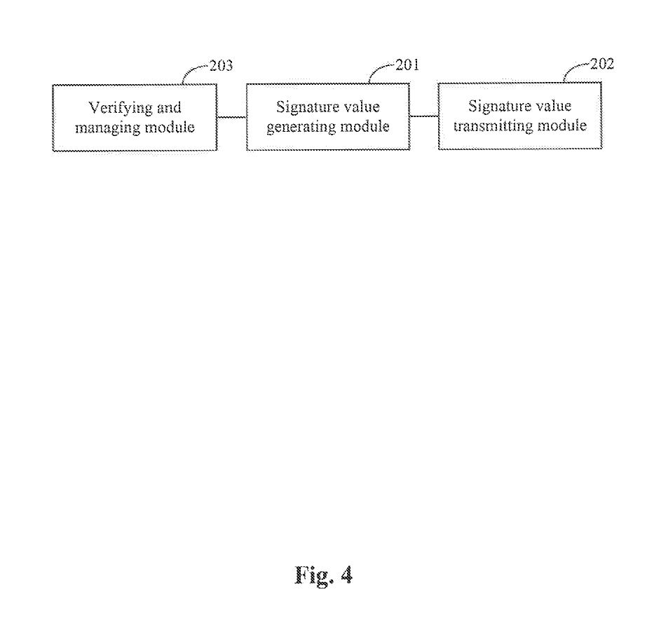

FIG. 4 illustrates a block diagram of the server 20 in the digital right management system 200 (FIG. 2), according to an exemplary embodiment. Referring to FIGS. 2 and 4, the server 20 may include a signature value generating module 201, a signature value transmitting module 202, and a verifying and managing module 203. These modules may be implemented by executing one or more programs by one or more processors.

In exemplary embodiments, the signature value generating module 201 may be configured to receive data, including a generated digest value, transmitted from the first user equipment 21, and to generate a signature value from the digest value.

For example, the signature value generating module 201 may sign the digest value using an encryption algorithm based on an RSA public key to obtain the signature value for verifying an authorization certificate for validity. Other exemplary signing algorithms include ElGamal, Fiat-Shamir, Guillou-Quisquarter, Schnorr, an Ong-Schnorr-Shamir digital signing algorithm, a Des/DSA elliptical-curve digital signing algorithm, a finite-automatic-machine digital signing algorithm, etc.

In exemplary embodiments, the signature value transmitting module 202 may be configured to transmit the generated signature value to the first user equipment 21.

In exemplary embodiments, the verifying and managing module 203 may be configured to determine that a sum of a number of user equipments which have shared the digital contents (i.e., first user equipments which have been bound with the digital contents) and a number of user equipments intended to share the digital contents (i.e., second user equipments) is not larger than a maximum allowable number of sharing devices that can share the digital contents. For example, the number of user equipments which have shared the digital contents is determined by the server 20 from the number of user equipments using an authorization certificate corresponding to the digital contents or from the number of user equipments bound with the digital contents in the registration unit, and the number of user equipments to share the digital contents is determined based on by the number of obtained equipment identifiers of second user equipments 22.

In exemplary embodiments, the server 20 may determine the digital contents corresponding to a CID in the received data transmitted from the first user equipment 21 and obtains the maximum allowable number N of sharing devices corresponding to the digital contents (where N is a positive integer). The server 20 may also determine the sum of the number of user equipments which have shared the digital contents and the number of second user equipments 22 currently applying for sharing, and verify whether sharing of the digital contents by a user has reached the maximum allowable number N of sharing devices corresponding to the digital contents. If the sum of the number of first user equipments 21 which have shared the digital contents and the number of second user equipments 22 currently applying for sharing is not larger than the maximum allowable number N of sharing devices corresponding to the digital contents, the verification succeeds, and the sharing request may be determined to be valid. If the sum of the number of first user equipments 21 which have shared the digital contents and the number of second user equipments 22 currently applying for sharing is larger than the maximum allowable number N of sharing devices corresponding to the digital contents, the verification fails, and the sharing request of the first user equipment 21 is rejected.

In exemplary embodiments, when the sum of the number of first user equipments 21 which have shared the digital contents and the number of second user equipments 22 is larger than the maximum allowable number N of sharing devices corresponding to the digital contents, the server 20 may reject the sharing request and notify the first user equipment 21 of the remaining number of sharing devices of the digital contents (that is, the maximum allowable number N of sharing devices corresponding to the digital contents minus the number of user equipments which have shared the digital contents). The first user equipment 21 may re-determine the number of second user equipments 22 intended to share the digital contents from the received remaining number of sharing devices of the digital contents so that the sum of the number of user equipments which have shared the digital contents and the number of second user equipments 22 is not larger than the maximum allowable number of sharing devices corresponding to the digital contents.

In exemplary embodiments, when the sum of the number of first user equipments 21 which have shared the digital contents and the number of second user equipments 22 is larger than the maximum allowable number N of sharing devices corresponding to the digital contents, the server 20 may select a few of the second user equipments 22 so that the sum of the number of user equipments which have shared the digital contents and the number of selected second user equipments is not larger than the maximum allowable number of sharing devices corresponding to the digital contents.

In exemplary embodiments, the verifying and managing module 203 may be further configured to verify the identity of the first user equipment 21 against user identity information and an equipment identifier of the first user equipment 21 to determine whether the first user equipment 21 is a legal possessor of the authorization certificate, before determining that the sum of the number of user equipments which have shared the digital contents and the number of second user equipments 22 is not larger than the maximum allowable number N of sharing devices corresponding to the digital contents.

In one exemplary embodiment, the received user identity information and the equipment identifier of the first user equipment 21 may be compared with data stored in the registration information library. If they are consistent, the verification succeeds, that is, the first user equipment 21 is determined to be a legal possessor of the authorization certificate. If they are inconsistent, the verification fails, that is, the first user equipment 21 is determined not to be a legal possessor of the authorization certificate, and the sharing request is rejected.

In exemplary embodiments, the verifying and managing module 203 may be further configured to verify the digest value Hsx generated by the first user equipment 21 after determining that the sum of the number of first user equipments 21 which have shared the digital contents and the number of second user equipments 22 is not larger than the maximum allowable number N of sharing devices corresponding to the digital contents.

For example, a ciphertext SK of a key of the digital contents in the sharing request may be obtained, an original authorization certificate corresponding to the first user equipment 21 may be obtained from the certification library, and a hash operation may be re-performed on the ciphertext SK_{c} and a right item P′ in the original authorization certificate to obtain a comparison digest value H′_{SK}, i.e., H(SK_{c}+P′)=H′_{SK}. H′_{SK} and H_{SK} may then be compared to determine consistency. If they are consistent, verification of the digest value succeeds. If they are inconsistent, the sharing request is rejected.

In exemplary embodiments, the verifying and managing module 203 may be further configured, after the verification of the digest value succeeds, to register all of the second user equipments 22 according to their respective equipment identifiers and to store registration information of the second user equipments 22 in the registration information library.

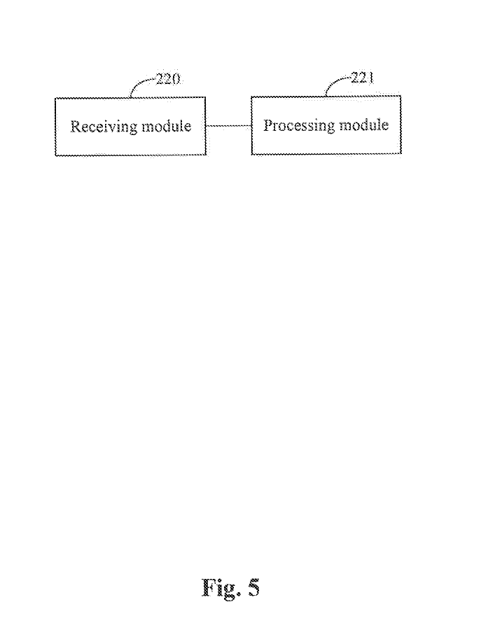

FIG. 5 illustrates a block diagram of the second user equipment 22 in the digital right management system 200 (FIG. 2), according to an exemplary embodiment. Referring to FIGS. 2 and 5, the second user equipment 22 includes a receiving module 220 and a processing module 221. These modules may be implemented by executing one or more computer programs on one or more processors.

In exemplary embodiments, the receiving module 220 may be configured to receive a new authorization certificate and corresponding digital contents transmitted from the first user equipment 21. The processing module 221 may be configured to decrypt a ciphertext of a key of the digital contents in the new authorization certificate with an equipment key of the second user equipment 22 to obtain the key of the digital contents and further access the digital contents corresponding to the new authorization certificate.

For example, upon reception of the new authorization certificate and the corresponding digital contents transmitted from the first user equipment 21, the processing module 221 may obtain an equipment identifier of the second user equipment 22, generate the equipment key of the second user equipment 22 from the equipment identifier of the second user equipment 22, and decrypt the ciphertext of the key of the digital contents in the new authorization certificate with the equipment key of the second user equipment 22 to further access the digital contents.

In one exemplary embodiment, upon reception of the new authorization certificate transmitted from the first user equipment 21, the second user equipment 22 may first verify a signature value in the new authorization certificate for validity against an identity certificate of the server 20, and further decrypts the ciphertext of the key of the digital contents in the new authorization certificate with the equipment key of the second user equipment 22 to thereby access the digital contents, after determining the signature value is valid.

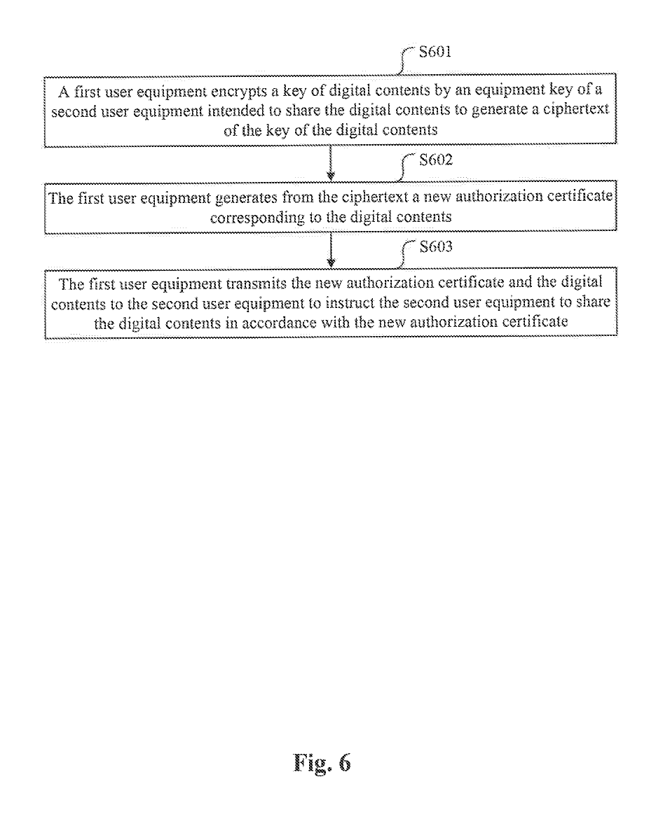

FIG. 6 illustrates a flowchart of a digital right management method performed by a first user equipment, such as the first user equipment 21 in the digital right management system 200 (FIG. 2), according to an exemplary embodiment. Referring to FIG. 6, in step S601, the first user equipment 21 may encrypt a key of digital contents with an equipment key of a second user equipment intended to share the digital contents to generate a ciphertext of the key of the digital contents. In step S602, the first user equipment 21 may generate from the ciphertext a new authorization certificate corresponding to the digital contents. In step S603, the first user equipment 21 may transmit the new authorization certificate and the digital contents to the second user equipment 22 to instruct the second user equipment 22 to share the digital contents based on the new authorization certificate.

In exemplary embodiments, generating the ciphertext of the key of the digital contents in step S601 may further include: the first user equipment 21 may encrypt the key of the digital contents with the equipment key of the first user equipment and the equipment key of the second user equipment to generate the ciphertext of the key of the digital contents.

After step S602, the first user equipment 21 may replace an original authorization certificate corresponding to the first user equipment with the new authorization certificate.

When there are a plurality of second user equipments, the first user equipment 21 generating a ciphertext of the key of the digital contents in step S601 may include: for each of the second user equipments 22, the first user equipment 21 may encrypt the key of the digital contents by an equipment key of the second user equipment 22 to generate a ciphertext of the key of the digital contents corresponding to the second user equipment 22. Additionally and/or alternatively, the first user equipment 21 may encrypt the key of the digital contents with equipment keys of all of the second user equipments 22 to generate a ciphertext of the key of the digital contents corresponding to all of the second user equipments 22.

Generating a new authorization certificate in step S602 may include: the first user equipment may determine a digest value from the generated ciphertext and an original authorization certificate corresponding to the digital contents, transmit a sharing request including the digest value to a server and receives a signature value, from the server, generated from the digest value. The first user equipment may generate the new authorization certificate from the signature value, the ciphertext and the original authorization certificate.

In exemplary embodiments, before generating the ciphertext of the key of the digital contents in step S601, the first user equipment 21 may select at least one of user equipments currently connected with the first user equipment as the second user equipment 22, obtain an equipment identifier of the second user equipment 22 and generate the equipment key of the second user equipment 22 from the equipment identifier of the second user equipment. Additionally and/or alternatively, the first user equipment 21 may select at least one of user equipments transmitting a request to the first user equipment 21 for sharing the digital contents as the second user equipment 22, obtain an equipment identifier of the second user equipment 22, and generate the equipment key of the second user equipment 22 from the equipment identifier of the second user equipment 22. For example, the first user equipment 21 and the second user equipment 22 may communicate with each other through Bluetooth, infrared or Wireless Fidelity (WIFI).

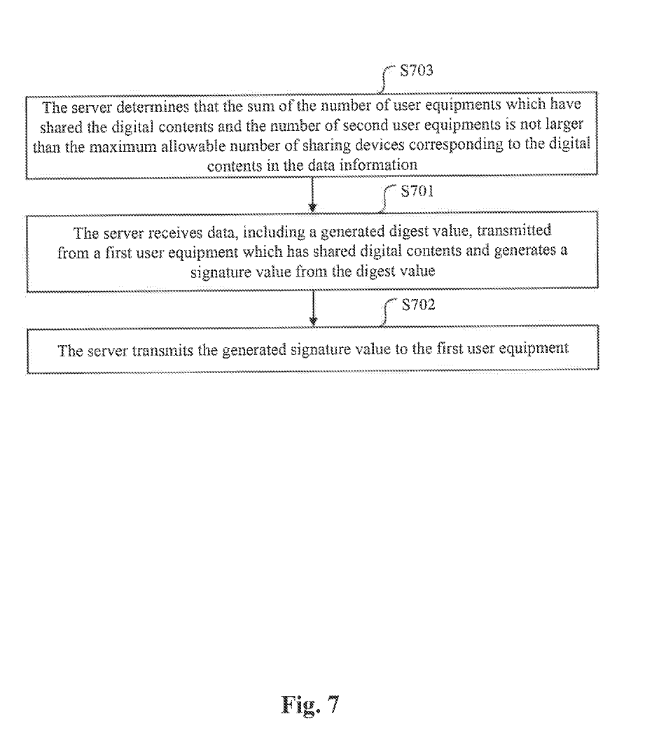

FIG. 7 illustrates a flowchart of a digital right management method performed by a server, such as the server 20 in the digital right management system 200 (FIG. 2), according to an exemplary embodiment. Referring to FIG. 7, in step S701, the server may receive data, including a generated digest value, transmitted from a first user equipment which has shared digital contents and generate a signature value from the digest value. In step S702, the server may transmit the generated signature value to the first user equipment 21. Before the server generates the signature value in step S701, the server may determine that the sum of the number of user equipment which have shared the digital contents and the number of second user equipments is not larger than the maximum allowable number of sharing devices of the digital contents (step S703).

For example, the number of user equipments which have shared the digital contents may be determined from authorization information or registration information stored in the server 20, and the number of second user equipments may be determined from the number of identifiers of second user equipments 22.

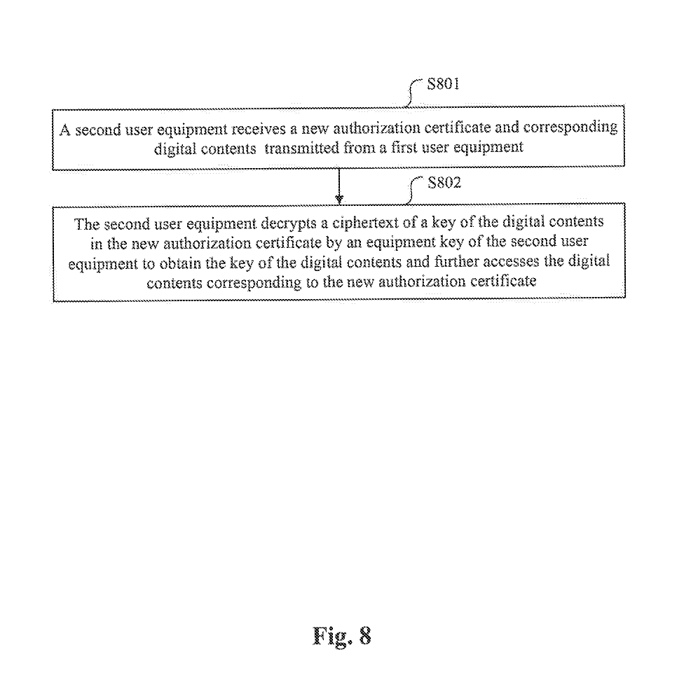

FIG. 8 illustrates a flowchart of a digital right management method performed by a second user equipment, such as the second user equipment 22 in the first digital right management system 100 (FIG. 2), according to an exemplary embodiment. Referring to FIG. 8, in step S801, the second user equipment 22 may receive a new authorization certificate and corresponding digital contents transmitted from a first user equipment 21. In step S802, the second user equipment 22 may decrypt a ciphertext of a key of the digital contents in the new authorization certificate by an equipment key of the second user equipment to obtain the key of the digital contents and further access the digital contents corresponding to the new authorization certificate.

In exemplary embodiments, after receiving the new authorization certificate and the corresponding digital contents transmitted from the first user equipment 21, the second user equipment 22 may obtain its own equipment identifier, generate its own equipment key from its own equipment identifier, and decrypt the ciphertext of the key of the digital contents in the new authorization certificate with its own equipment key to access the digital contents.

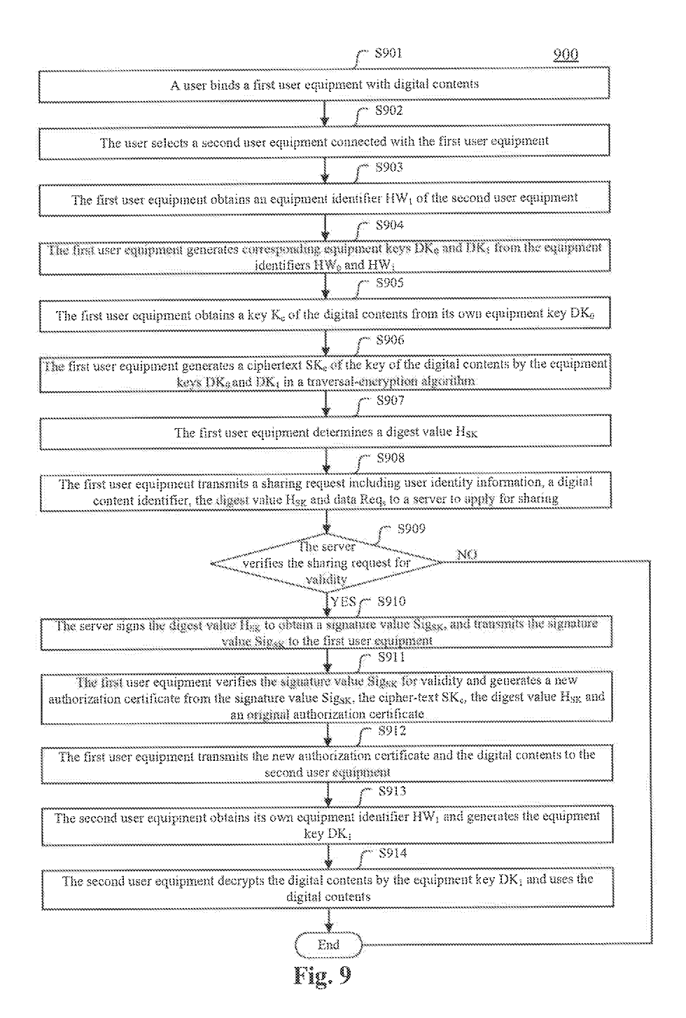

FIG. 9 illustrates a flowchart of a digital right management method 900 performed by the system 200 (FIG. 2), according to an exemplary embodiment. Referring to FIGS. 2 and 9, in the method 900, the first user equipment 21 may generate a ciphertext of a key of digital contents with an equipment key of the first user equipment 21 and an equipment key of the second user equipment 22. As illustrated in FIG. 9, the method may include the following steps:

Step S901: A user may bind the first user equipment 21 with digital contents;

Step S902: The user may select the second user equipment 22 connected with the first user equipment 21;

Step S903: The first user equipment 21 may obtain its own equipment identifier HW₀ and an equipment identifier HW₁ of the second user equipment 21;

Step S904: The first user equipment 21 may generate corresponding equipment keys DK₀ and DK₁ from the equipment identifiers HW₀ and HW₁, respectively;

Step S905: The first user equipment 21 may obtain a key K_{c} of the digital contents from its own equipment key DK₀;

Step S906: The first user equipment 21 may generate a ciphertext SK_{c} of the key of the digital contents by the equipment keys DK₀ and DK₁ using a traversal-encryption algorithm;

Step S907: The first user equipment 21 may determine a digest value H_{SK};

Step S908: The first user equipment 21 may transmit a sharing request including user identity information, a digital content identifier, the digest value H_{SK} and data Reqₛ to the server to apply for sharing;

Step S909: The server 20 may verify the received sharing request for validity; and if the verification succeeds, the process goes to step S910; otherwise, the server may reject the sharing request, and the process ends;

Step S910: The server 20 may sign the digest value H_{SK} to obtain a signature value Sig_{SK}, and transmit the signature value Sig_{SK} to the first user equipment 21;

Step S911: The first user equipment 21 may verify the signature value Sig_{SK} for validity and generate a new authorization certificate from the signature value Sig_{SK}, the ciphertext SK_{c} the digest value H_{SK} and an original authorization certificate;

Step S912: The first user equipment 21 may transmit the new authorization certificate and the digital contents to the second user equipment 22;

Step S913: The second user equipment 22 may obtain its own equipment identifier HW₁ and generates the equipment key DK₁; and

Step S914: The second user equipment 22 may decrypt the digital contents by the equipment key DK₁ and use the digital contents normally, and the process may end.

In exemplary embodiments, the first user equipment 21 may generate a new authorization certificate from an equipment key of a second user equipment 22 intended to share digital contents and transmit the new authorization certificate to the second user equipment 22 intended to share the digital contents, so that the second user equipments 22 can share the corresponding digital contents as per the received new authorization certificate, thus enabling a user to add a new user equipment to share digital contents in response to a change in type or use environment of the digital contents in the course of using the digital contents.

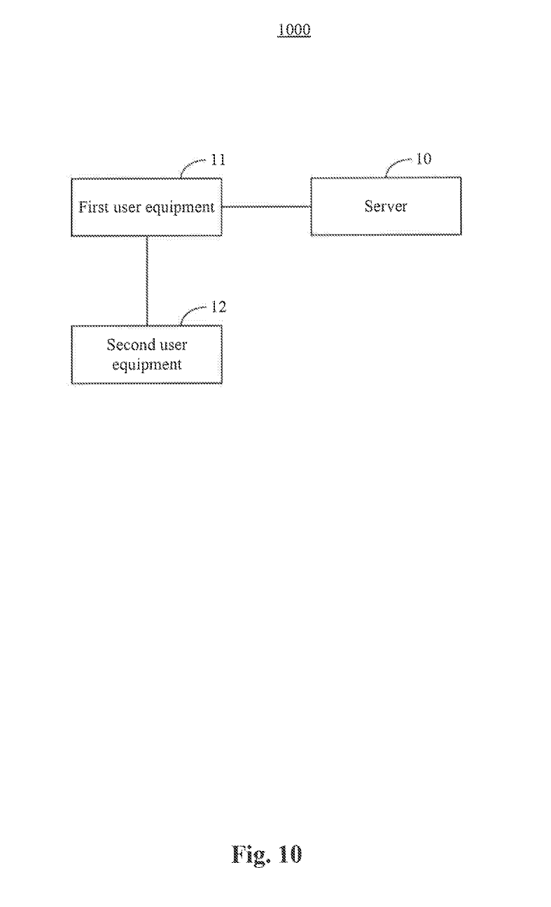

FIG. 10 illustrates a block diagram of a digital right management system 1000, according to an exemplary embodiment. Referring to FIG. 10, the system 1000 includes a server 10, a first user equipment 11 which has shared digital contents, and a second user equipment 12 intended to share the digital contents.

In exemplary embodiments, the server 10 may be configured to encrypt a key of digital contents with an equipment key of the second user equipment 12 intended to share the digital contents to generate a ciphertext of the key of the digital contents, to generate from the ciphertext a new authorization certificate corresponding to the digital contents, and to transmit the new authorization certificate to the second user equipment 12 through a first user equipment 11 to instruct the second user equipment 12 to share the digital contents in accordance with the new authorization certificate.

In exemplary embodiments, the first user equipment 11 may be configured to obtain an equipment identifier of the second user equipment 12, to transmit the equipment identifier of the second user equipment 12 to the server 10, and to transmit the new authorization certificate generated by the server 10 and the digital contents to the second user equipment 12.

In exemplary embodiments, the second user equipment 12 may be configured to receive the new authorization certificate and the corresponding digital contents transmitted from the first user equipment 11, and to decrypt the ciphertext of the key of the digital contents in the new authorization certificate by the equipment key of the second user equipment 12 to obtain the key of the digital contents and further access the digital contents corresponding to the new authorization certificate.

In exemplary embodiments, before adding a new user equipment to share digital contents, a user may first bind selected user equipments with the digital contents over a network in the same binding process as the digital right management system 200 illustrated in FIG. 2.

In exemplary embodiments, the first user equipment 11 may be configured to select at least one of user equipments connected therewith as the second user equipment 12 intended to share the digital contents. For example, the first user equipment 11 and the second user equipment 12 may communicate with each other through Bluetooth, infrared or Wireless Fidelity (WIFI). The first user equipment 11 may also be configured to obtain the equipment identifier of the second user equipment 12 in a communication protocol with the second user equipment 12; and to transmit data and a sharing request to the server 10. The transmitted data may include an equipment identifier of the first user equipment 1, the equipment identifier of the second user equipment 12, user identity information, and a CID of the digital contents.

In exemplary embodiments, in the course of interaction between the first user equipment 11 and the server 10, a part or all of transmission data may be encrypted to protect the transmission data for security. For example, the first user equipment 11 may encrypt the equipment identifier HW₀ of the first user equipment 11 and the equipment identifier HW₁ of the second user equipment 12 with a public key PubKau of the server 10 to obtain encrypted data Reqₛ, that is, E(HW₀, HW₁|PubK_{RI})=Reqₛ, and transmit the user identity information, the CID of the digital contents, and the encrypted data Req, to the server 10.

Upon receiving the data information transmitted from the first user equipment 11, the server 10 may decrypt the encrypted data with its own private key PriK_{RI} and then perform a further verification operation to thereby ensure the security of the data.

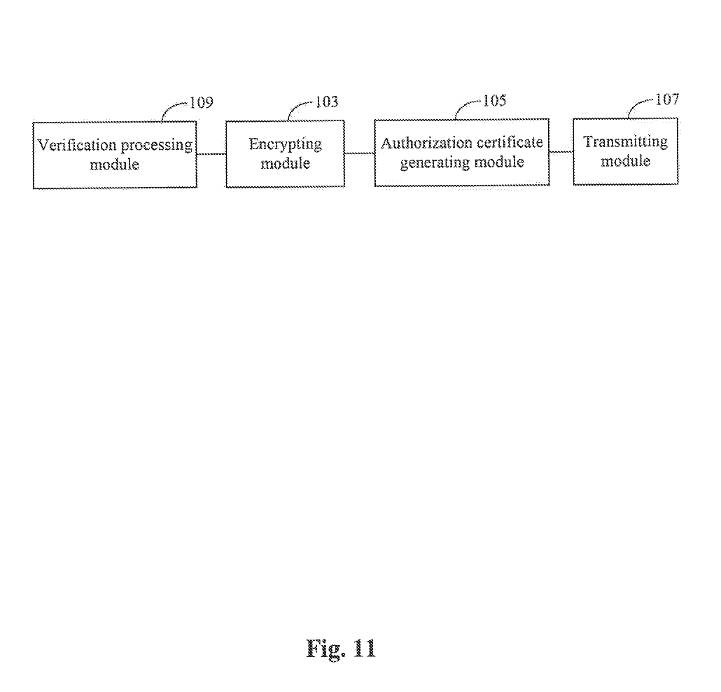

FIG. 11 illustrates a block diagram of the server 10 in the digital right management system 1000 (FIG. 10), according to an exemplary embodiment. Referring to FIGS. 10 and 11, the server 10 may include an encrypting module 103, an authorization certificate generating module 105, a transmitting module 107, and a verification processing module 109.

In exemplary embodiments, the encrypting module 103 may be configured to encrypt a key of digital contents with the equipment key of the second user equipment 12 intended to share the digital contents to generate a ciphertext of the key of the digital contents. The authorization certificate generating module 105 may be configured to generate from the ciphertext a new authorization certificate corresponding to the digital contents. The transmitting module 107 may be configured to transmit the new authorization certificate to the second user equipment 12 through the first user equipment 11 to instruct the second user equipment 12 to share the digital contents in accordance with the new authorization certificate.

When there are a plurality of second user equipments, the encrypting module 103 may generate a ciphertext of the key of the digital contents using the two processing approaches described above in connection with the ciphertext generating module 210 of the first user equipment 21 (FIG. 3).

In exemplary embodiments, the encrypting module 103 may be further configured to encrypt the key of the digital contents by an equipment key of the first user equipment 11 and the equipment key of the second user equipment 12 intended to share the digital contents to generate a ciphertext of the key of the digital contents. The ciphertext may be obtained by encrypting the key of the digital contents with the equipment key of the first user equipment 11 and the equipment key of the second user equipment 12 using a traversal-encryption algorithm, and the equipment key of the first user equipment 11 may be generated from an equipment identifier of the first user equipment 11.

The authorization certificate generating module 105 may be further configured to replace an original authorization certificate of the first user equipment 11 with the new authorization certificate corresponding to the digital contents after generating the new authorization certificate from the ciphertext.

When there are a plurality of second user equipments, the encrypting module 103 may also generate the ciphertext of the key of the digital contents using the above-described two approaches except that in the first approach, for each of the second user equipments, the encrypting module 103 encrypts the key of the digital contents by the equipment key of the first user equipment 11 and the equipment key of the second user equipment 12 using a traversal-encryption algorithm; and in the second approach, the encrypting module 103 encrypts the key of the digital contents with the equipment key of the first user equipment 11 and equipment keys of the plurality of second user equipments in a traversal-encryption algorithm.

In exemplary embodiments, the verification processing module 109 may be configured to determine that a sum of a number of user equipments which have shared digital contents and a number of second user equipments is not larger than the maximum allowable number of sharing devices corresponding to the digital contents, using a verification process similar to that described above in connection with the verification processing module 203 of the server 20 (FIG. 4).

In exemplary embodiments, the verification processing module 109 may be further configured to verify the identity of the first user equipment 11 against user identity information and the equipment identifier of the first user equipment 11 to determine whether the first user equipment 11 is a legal possessor of the authorization certificate, before determining that the sum of the number of user equipments which have shared the digital contents and the number of second user equipments 12 is not larger than the maximum allowable number of sharing devices corresponding to the digital contents, using a verification process similar to that described above in connection with the verification processing module 203 of the server 20 (FIG. 4).

In exemplary embodiments, the verification processing module 109 may be further configured to register the second user equipment 12 according to an equipment identifier of the second user equipment 12 and store registration information of the second user equipment 12 in a registration information library, after determining that the sum of the number of user equipments which have shared the digital contents and the number of second user equipments 12 is not larger than the maximum allowable number of sharing devices corresponding to the digital contents.

In exemplary embodiments, the authorization certificate generating module 105 may be configured to determine a digest value from the generated ciphertext and a right item in an original authorization certificate corresponding to the digital contents and to sign the digest value to obtain a signature value.

In one exemplary embodiment, after the ciphertext of the key of the digital contents is generated, an original authorization certificate may be obtained from the authorization information library, a right item is extracted from the original authorization certificate, a hash operation is performed on the right item and the ciphertext of the key of the digital contents to obtain a digest value, the generated digest value is signed to obtain a signature value, and the new authorization certificate is generated from the generated signature value, the generated ciphertext, and the original authorization certificate.

The second user equipment 12 intended to share digital contents may transmit its own equipment identifier to the server 10 through the first user equipment 11 which is connected with the second user equipment 12 and which has shared the digital contents, and the new authorization certificate generated by the server 10 may be transmitted to the second user equipment 12 through the first user equipment 11. As a result, the second user equipment 12 may be added through the first user equipment 11 to share the digital contents regardless of whether or not the second user equipment 12 is a network device.

In exemplary embodiments, the second user equipment 12 may be implemented in a similar way to the second user equipment 22 illustrated in FIG. 5.

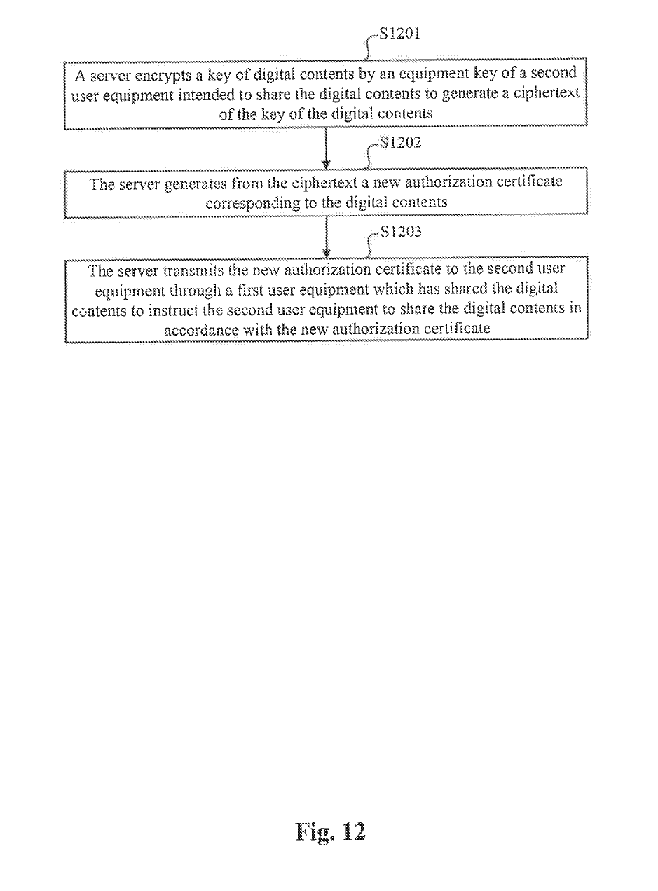

FIG. 12 illustrates a flowchart of a digital right management method 1200 performed by a server, such as the server 10 (FIG. 10), according to an exemplary embodiment. Referring to FIG. 12, in step S1201, the server may encrypt a key of digital contents with an equipment key of a second user equipment, such as the second user equipment 12 (FIG. 10), intended to share the digital contents to generate a ciphertext of the key of the digital contents. In step S1202, the server may generate from the ciphertext a new authorization certificate corresponding to the digital contents. In step S1203, the server may transmit the new authorization certificate to the second user equipment through a first user equipment which has shared the digital contents, such as the first user equipment 11 (FIG. 10), to instruct the second user equipment to share the digital contents in accordance with the new authorization certificate.

In exemplary embodiments, the server may encrypt the key of the digital contents with an equipment key of the first user equipment and the equipment key of the second user equipment to generate the ciphertext of the key of the digital contents. The server may also transmit the new authorization certificate to the first user equipment to instruct the first user equipment to replace an original authorization certificate corresponding to the first user equipment with the new authorization certificate.

In exemplary embodiments, when there are a plurality of second user equipments, for each one of the second user equipments, the server may encrypt the key of the digital contents with an equipment key of the one of the second user equipments to generate a ciphertext of the key of the digital contents corresponding to the one of the second user equipment. Alternatively and/or additionally, the server may encrypt the key of the digital contents by a plurality of equipment keys of all of the second user equipments, respectively, to generate a ciphertext of the key of the digital contents corresponding to all of the second user equipments.

In exemplary embodiments, the server may generate the equipment key of the first user equipment from an equipment identifier of the first user equipment and the equipment key of the second user equipment from an equipment identifier of the second user equipment.

In exemplary embodiments, generating the new authorization certificate in step S1202 may include that the server may determine a digest value from the generated ciphertext and a right item in an original authorization certificate corresponding to the digital contents and sign the digest value to obtain a signature value. For example, after generating the ciphertext of the key of the digital contents, the server may obtain the original authorization certificate from the authorization information library, extract the right item from the original authorization certificate, and perform a hash operation on the right item and the ciphertext of the key of the digital contents to obtain the digest value. The server may then sign the generated digest value to obtain the signature value, and generate the new authorization certificate from the generated signature value, the generated ciphertext, and the original authorization certificate.

In step S1203, the server may transmit the new authorization certificate to the second user equipment through the first user equipment. In one exemplary embodiment, the server may transmit the generated new authorization certificate to the first user equipment, and the first user equipment may transmit the new authorization certificate and the digital contents to the second user equipment connected with the first user equipment to instruct the second user equipment to share the digital contents as per the new authorization certificate.

In exemplary embodiments, the functional modules of the first user equipment 21 illustrated in FIG. 3 and of the first user equipment 11 illustrated in FIG. 10 can be integrated in a single user equipment, and different functional modules can be selected as needed for a user in the course of using the user equipment.

Since a first user equipment and a second user equipment can be interchanged in a different use environment, the first user equipment 21 illustrated in FIG. 3 can also include the functional modules of the second user equipment 22 illustrated in FIG. 5, and the first user equipment 11 illustrated in FIG. 10 can also include the functional modules of the second user equipment 22 illustrated in FIG. 5.

In exemplary embodiments, the functional modules of the server 10 illustrated in FIG. 11 and of the server 20 illustrated in FIG. 4 can be integrated in a single server, and different functional modules can be selected as needed for a user.

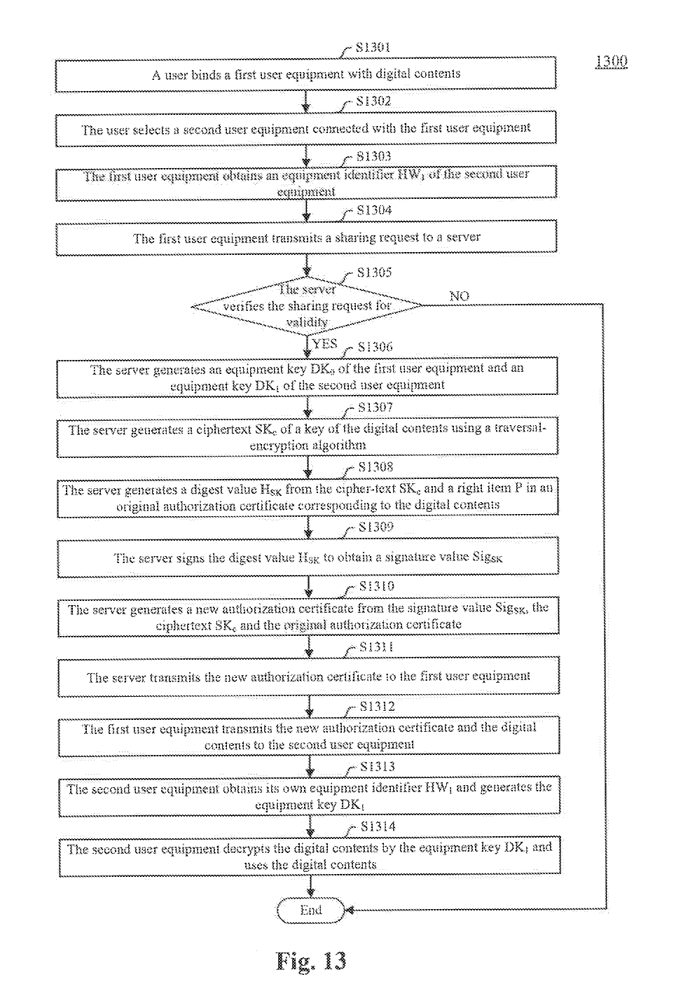

FIG. 13 illustrates a flowchart of a digital right management method 1300 performed by the system 1000 (FIG. 10), according to an exemplary embodiment. Referring to FIGS. 10 and 13, in the method 1300, the server 10 may generate a ciphertext of a key of digital contents with the equipment key of the first user equipment 11 and the equipment key of the second user equipment 12. As illustrated in FIG. 13, the method includes the following steps.

Step S1301: A user may bind the first user equipment 11 with digital contents;

Step S1302: The user may select the second user equipment 12 connected with the first user equipment 11,

Step S1303: The first user equipment 11 may obtain an equipment identifier HW₁ of the second user equipment 12;

Step S1304: The first user equipment 11 may transmit a sharing request and data to the server 10, where the data includes user identity information, a digital content identifier, and an encrypted identifier HW₀ of the first user equipment 11 and identifier HW₁ of the second user equipment 12;

Step S1305: The server 10 may verify the sharing request for validity; and if the verification succeeds, the process may go to step S1306; otherwise, the server 10 may reject the sharing request, and the process ends;

Step S1306: The server 10 may generate an equipment key DK₀ of the first user equipment 11 and an equipment key DK₁ of the second user equipment 12;

Step S1307: The server 10 may generate a ciphertext SK, of the key of the digital contents using a traversal-encryption algorithm, that is, TraverseEncrypt (K_{c}|DK₀, DK₁)=SK_{c};

Step S1308: The server 10 may generate a digest value H_{SK} from the ciphertext SK_{c} and a right item P in an original authorization certificate corresponding to the digital contents;

Step S1309: The server 10 may sign the digest value H_{SK} to obtain a signature value Sig_{SK};

Step S1310: The server 10 may generate a new authorization certificate from the signature value Sig_{SK}, the ciphertext SK_{c}, and the original authorization certificate;

Step S1311: The server may transmit the new authorization certificate to the first user equipment 11;

Step S1312: The first user equipment 11 may transmit the new authorization certificate and the digital contents to the second user equipment 12;

Step S1313: The second user equipment 12 may obtain its own equipment identifier HW₁ and generates the equipment key DK₁; and

Step S1314: The second user equipment 12 may decrypt the digital contents with the equipment key DK₁ and uses the digital contents, and the process ends.

It is understood that the equipment key generated by the first user equipment 11 from its own equipment identifier may be the same as the equipment key generated by the server 10 from the equipment identifier of the first user equipment 11; and the equipment key generated by the second user equipment 12 from its own equipment identifier and the equipment key generated by the first user equipment 11 from the equipment identifier of the second user equipment 12 may be the same as the equipment key generated by the server 10 from the equipment identifier of the second user equipment 12.

The server 10 may generate the new authorization certificate from the equipment key of the second user equipment 12 and transmits the new authorization certificate to the second user equipment 12 intended to share digital contents through the first user equipment 11, so that the second user equipment 12 may share the corresponding digital contents in accordance with the received new authorization certificate, thus enabling the user to add a new user equipment to share digital contents in response to a change in type or use environment of the digital contents in the course of using the digital contents.

Compared to the cases in which sharing digital contents among a plurality of user equipments is at a user-level granularity, that is, a server may limit the largest number of user equipments that can be registered for each user, and for different digital contents used by the user, the user can only select user equipment(s) from the registered user equipments to share the different digital contents, the present disclosure provides sharing digital contents among a plurality of user equipments at a digital content-level granularity, that is, for different digital contents used by each user, the largest numbers of user equipments sharing the respective digital contents are set respectively to enable the user to make flexible setting dependent upon the type of user equipment or the type of digital contents in the course of using the different digital contents. Since the number of user equipments sharing digital contents of each user is set for the digital contents instead of uniformly setting the number of sharing user equipments of the user, the flexibility of an authorization system and a good experience of the user can be further improved.

In exemplary embodiments, in order to enable shared digital contents to be adaptive in a specific range to a change in hardware configuration environment of a user equipment, a secrete sharing mechanism may be incorporated after a ciphertext of a key of the digital contents is generated so that equipment components of the user equipment may be obtained, the ciphertext of the key of the digital contents can be broken in a (t,n) threshold method into n shared sub-keys which are bound respectively with the equipment components of the user equipment, thus ensuring that the user can change conveniently and flexibly a hardware configuration environment of the currently used user equipment without influence of the use of the digital contents on the precondition that the digital contents are used securely and reasonably.

In exemplary embodiments, in the course of interaction of the frst user equipment with the server, a part or all of contents in transmission data may be encrypted in order to protect user data for privacy. For example, the first user equipment may encrypt and encapsulate an equipment identifier, the ciphertext of the key of digital contents, and other data transmitted from the first user equipment with a public key of the server, and transmit an encryption and encapsulation result to the server. Upon reception of the encrypted data transmitted from the first user equipment, the server decrypts the encapsulated information with its own private key and then performs a further verification operation on the data, thus ensuring the security of the data.

In exemplary embodiments, in the course of interaction between the first user equipment with the server, in order to improve the efficiency of sharing among devices, firstly the remaining number J of sharing devices of digital contents may be obtained from the server, and the first user equipment may determine the number n of second user equipments intended to share the digital contents from the number of received equipment identifiers of the second user equipments, intended to share the digital contents, transmitted from the second user equipments and determine whether n is smaller than or equal to J, to thereby verify the number of second user equipments applying for sharing. The server may provide a sharing application blacklist corresponding to the digital contents so that the first user equipment may check a sharing application for legality against the blacklist.

In exemplary embodiments, in order to ensure the security of interconnection between user equipments, an encryption algorithm and an encryption key to encrypt an equipment identifier may be prescribed between the first user equipment and the second user equipment connected therewith. Upon reception of an encrypted equipment identifier transmitted from the second user equipment, the first user equipment may first decrypt the encrypted equipment identifier in a prescribed decryption algorithm and decryption key to obtain a plaintext of the equipment identifier and then performs a subsequent process.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1. A digital right management method, comprising:
encrypting, by a first user equipment which has access right to shared digital contents, a key of the digital contents with at least an equipment key of a second user equipment intended to share the digital contents to generate a ciphertext of the key of the digital contents;
generating, by the first user equipment, from the ciphertext a new authorization certificate corresponding to the digital contents; and
transmitting, by the first user equipment, the new authorization certificate and the digital contents to the second user equipment to instruct the second user equipment to share the digital contents in accordance with the new authorization certificate.

2. The method of claim 1, wherein encrypting the key of the digital contents further comprises:
encrypting the key of the digital contents by an equipment key of the first user equipment and the equipment key of the second user equipment to generate the ciphertext of the key of the digital contents.

3. The method of claim 2, further comprising:
replacing, by the first user equipment, an original authorization certificate corresponding to the first user equipment with the new authorization certificate.

4. The method of claim 1, further comprising:
selecting, by the first user equipment, at least one user equipment which does not share the digital content from a plurality of user equipments each currently connected with the first user equipment or transmitting a request to the first user equipment for sharing the digital contents, as the second user equipment;
obtaining an equipment identifier of the second user equipment; and
generating the equipment key of the second user equipment from the equipment identifier of the second user equipment.

5. The method of claim 4, wherein when there are a plurality of second user equipments, the method comprises:
for each one of the second user equipments, encrypting by the first user equipment the key of the digital contents with an equipment key of one of the second user equipments to generate a ciphertext of the key of the digital contents corresponding to the one of the second user equipments.

6. The method of claim 4, wherein when there are a plurality of second user equipments, the method comprises:
encrypting by the first user equipment the key of the digital contents by equipment keys of all of the second user equipments to generate a ciphertext of the key of the digital contents corresponding to all of the second user equipments.

7. The method of claim 1, wherein generating the new authorization certificate comprises:
determining a digest value based on the generated ciphertcxt and an original authorization certificate corresponding to the digital contents;
transmitting data including the digest value to a server and receiving from the server a signature value generated from the digest value; and
generating the new authorization certificate based on the signature value, the ciphertext, and the original authorization certificate.

8. A first user equipment, comprising:
a ciphertext generating module configured to encrypt a key of digital contents with at least an equipment key of a second user equipment intended to share the digital contents to generate a ciphertext of the key of the digital contents;
an authorization certificate determining module coupled to the ciphertext generating module and configured to generate from the ciphertext a new authorization certificate corresponding to the digital contents; and
an authorization certificate transmitting module coupled to the authorization certificate determining module and configured to transmit the new authorization certificate and the digital contents to the second user equipment to instruct the second user equipment to share the digital contents in accordance with the new authorization certificate.

9. A digital right management method, comprising:
encrypting, by a server, a key of digital contents with at least an equipment key of a second user equipment intended to share the digital contents to generate a ciphertext of the key of the digital contents;
generating, by the server, from the ciphertext a new authorization certificate corresponding to the digital contents; and
transmitting, by the server, the new authorization certificate to the second user equipment through a first user equipment which has access to shared the digital contents, to instruct the second user equipment to share the digital contents in accordance with the new authorization certificate.

10. The method of claim 9, wherein encrypting the ciphertext of the key of the digital contents further comprises:
the server encrypting the key of the digital contents by an equipment key of the first user equipment and the equipment key of the second user equipment to generate the ciphertext of the key of the digital contents.

11. The method of claim 10, further comprising:
transmitting, by the server, the new authorization certificate to the first user equipment to instruct the first user equipment to replace an original authorization certificate corresponding to the first user equipment with the new authorization certificate.

12. The method of claim 9, wherein when there are a plurality of second user equipments, the method comprises:
for each one of the second user equipments, encrypting by the server the key of the digital contents with an equipment key of the one of the plurality of the second user equipments to generate a ciphertext of the key of the digital contents corresponding to the second user equipment.

13. The method of claim 9, wherein when there are a plurality of second user equipments, the method comprises:
encrypting, by the server, the key of the digital contents by equipment keys of all of the plurality of second user equipments to generate a ciphertext of the key of the digital contents corresponding to all of the plurality of second user equipments.

14. The method of claim 9, wherein generating the new authorization certificate comprises:
determining a digest value from the ciphertext and an original authorization certificate corresponding to the digital contents and signing the digest value to obtain a signature value; and
generating the new authorization certificate based on the signature value, the ciphertext, and the original authorization certificate.

15. The method of claim 9, wherein before the server generates the ciphertext of the key of the digital contents, the method further includes:
determining, by the server, that a sum of a number of user equipments which have access to shared digital contents and a number of second user equipments is not larger than a maximum allowable number of sharing devices corresponding to the digital contents.

16. A digital right management server, comprising:
an encrypting module configured to encrypt a key of digital contents with an equipment key of a second user equipment intended to share the digital contents to generate a ciphertext of the key of the digital contents;
an authorization certificate generating module coupled to the encrypting module and configured to generate from the ciphertext a new authorization certificate corresponding to the digital contents; and
a transmitting module coupled to the authorization certificate generating module and configured to transmit the new authorization certificate to the second user equipment through a first user equipment which has access to shared digital contents to instruct the second user equipment to share the digital contents in accordance with the new authorization certificate.
